(19) United States
(12) Patent Application Publication
(10) Pub. No.: US 2025/0124226 A1
(43) Pub. Date: Apr. 17, 2025

(54) Log anomaly detection method and apparatus, computer device, and storage medium

(71) Applicant: Dbappsecurity Co.,Ltd, Hangzhou (CN)

(72) Inventors: Chengang HONG, Hangzhou (CN); Weijia YANG, Hangzhou (CN); Bo LIU, Hangzhou (CN)

(21) Appl. No.: 18/540,926

(22) Filed: Dec. 15, 2023

(30) Foreign Application Priority Data
Oct. 17, 2023 (CN) 202311341155.7

(51) Int. Cl. G06F 40/284; G06F 11/34

(52) U.S. Cl. CPC G06F 40/284; G06F 11/3476

(57) ABSTRACT

The present disclosure relates to a log anomaly detection method and apparatus, a computer device, and a storage medium. By sampling first log data to obtain a sample set of the first log data, a sample with low availability is deleted in the sampling process; the sampling of the first log data is stopped in response to the sampling completeness being high, and a sample set of the first log data is outputted; and whether second log data is anomalous data is determined based on the probability of log events from the second log data falling into the sample set of the first log data. Due to real-time updating of the sample set based on the sample availability during sampling, dynamic adaption to changes of the log data can be realized, thereby improving the anomaly detection accuracy and detection efficiency of the dynamic log data.

### TECHNICAL FIELD

The present disclosure relates to the technical field of computer technology, and in particular to a log anomaly detection method and apparatus, a computer device, and a storage medium.

### BACKGROUND

With the rapid development of information technology and the Internet, the volume of log data generated by various systems and applications is growing exponentially. These log data provides a wealth of information about system operations, user behaviors, and potential security threats for system administrators and security experts. However, due to the massive volume and complexity of the data, manual analysis and processing of these log data have become impractical. As a result, an automated log anomaly detection technology has emerged, aiming to detect anomalies and potential threats in real time from a large volume of log data.

In the related art, anomaly detection for the log data is mainly based on rules and signatures. However, as the rules and signatures are determined one by one in this method for known threats and anomalies, the accuracy of detection is relatively low in response to there are new and unknown threats and anomalies. Additionally, as data complexity and diversity increase, the cost of creating and maintaining rules and signatures one by one also rises. Accordingly, machine learning methods are gradually adopted in the related technologies to perform anomaly detection on the log data. However, conventional machine learning methods tend to cause the phenomenon of “curse of dimensionality” or model drift in response to processing high-dimensional or dynamically changing log data. The phenomenon of “curse of dimensionality” usually refers to the difficulty caused by a high data dimensionality in response to performing similarity computations, distance computations, nearest neighbor queries, and other model training directly or indirectly based on above algorithms. Model drift refers to the degradation of old model effects under newest features over time. These phenomena can lead to reduced accuracy in log data anomaly detection.

Currently, there is no effective solution provided to solve the problem of low accuracy in dynamic log data anomaly detection in the related art.

### SUMMARY

At least some embodiments of the present disclosure provides a log anomaly detection method and apparatus, a computer device, and non-transitory storage medium for improving the accuracy of dynamic log data anomaly detection in response to the aforementioned technical problems.

In a first aspect, the present disclosure provides a log anomaly detection method. The method including:
first log data to obtain a sample set of the first log data is sampled, and at least one sample satisfying a first preset condition from the sample set is deleted, where the first preset condition is configured to represent availability of the at least one sample;
the sampling of the first log data is stopped in response to where the sampling of the first log data satisfying a second preset condition, and the sample set of the first log data is outputted, wherein the second preset condition is configured to represent a completeness of the sampling of the first log data;
whether second log data is an anomalous log data is determined based on a probability of log events contained in the second log data falling into the sample set of the first log data.

In an embodiment, before sampling the first log data, the method further includes:
the first log data is tokenized to obtain a tokenization result;
key information of the first log data is extracted based on the tokenization result; and
a feature vector of the first log data is obtained based on the key information.

In an embodiment, sampling the first log data includes:
a first sample is selected from the first log data;
a second sample is generated based on the first sample; and
a probability of the first sample in a target distribution, a probability of the second sample in the target distribution, a probability of the first sample in a proposed distribution and a probability of the second sample in the proposed distribution are calculated, and whether the second sample is retained is determined based on the probability of the first sample in the target distribution and the probability of the second sample in the target distribution, the probability of the first sample in the proposed distribution and the probability of the second sample in the proposed distribution, wherein the target distribution is a log data distribution corresponding to the first sample, and the proposed distribution is a log data distribution corresponding to the second sample.

In an embodiment, the step of generating the second sample based on the first sample includes:
a Laplace distribution of the first sample is obtained;
expected values of various samples relative to the first sample are calculated based on the Laplace distribution of the first sample; and
the second sample is generated based on the expected values.

In an embodiment, the first preset condition satisfies at least one of the followings: a retention time period of the sample being longer than a first preset value, and a weight of the sample being less than a second preset value.

In an embodiment, the second preset condition satisfies at least one of the followings: the number of iterations of the sample reaching a third preset value, a distribution of the sample reaching convergence, and a computation time period of the sample reaching a fourth preset value.

In an embodiment, the step of determining whether the second log data is the anomalous log data based on the probability of log events from the second log data falling into the sample set of the first log data includes:
an anomaly score for each log event in the second log data is generated based on the probability of log events from the second log data falling into the sample set of the first log data;
in response to the anomaly score exceeding a fifth preset value, an anomaly alert is triggered, and the second log data triggered anomaly is extracted and processed.

In an embodiment, the method further includes:
in response to the retention time period of the sample being longer than the first preset value, the at least one sample is determined being old and configured with lower availability;
in response to the weight of the sample being less than the second preset value, the at least one sample is determined configured with lower importance and availability.

In a second aspect, the present disclosure further provides a computer device. The computer device includes a memory and a processor. The memory stores a computer program, and the processor executes the computer program to achieve the following steps:
first log data to obtain a sample set of the first log data is sampled, and at least one sample satisfying a first preset condition from the sample set is deleted, where the first preset condition is configured to represent availability of the at least one sample;
the sampling of the first log data is stopped in response to where the sampling of the first log data satisfying a second preset condition, and the sample set of the first log data is outputted, wherein the second preset condition is configured to represent a completeness of the sampling of the first log data;
whether second log data is an anomalous log data is determined based on a probability of log events contained in the second log data falling into the sample set of the first log data.

In a third aspect, the present disclosure further provides a non-transitory storage medium. The non-transitory storage medium stores a computer program. The computer program, in response to executing by a processor, implements the following steps:
first log data to obtain a sample set of the first log data is sampled, and at least one sample satisfying a first preset condition from the sample set is deleted, where the first preset condition is configured to represent availability of the at least one sample;
the sampling of the first log data is stopped in response to where the sampling of the first log data satisfying a second preset condition, and the sample set of the first log data is outputted, wherein the second preset condition is configured to represent a completeness of the sampling of the first log data;
whether second log data is an anomalous log data is determined based on a probability of log events contained in the second log data falling into the sample set of the first log data.

Based on the log anomaly detection method and apparatus, the computer device, and the storage medium, by sampling the first log data to obtain a sample set of the first log data, the at least one sample with the low availability is deleted in the sampling process; the sampling of the first log data is stopped in response to the sampling completeness being high, and the sample set of the first log data is outputted; and whether the second log data is the anomalous data is determined according to the probability of the log events from the second log data falling into the sample set of the first log data. Due to real-time updating of the sample set based on the sample availability during sampling, dynamic adaption to changes of the log data can be realized; and anomaly detection can be continuously and effectively performed on the dynamic log data, thereby improving the anomaly detection accuracy and detection efficiency of the dynamic log data.

### BRIEF DESCRIPTION OF THE DRAWINGS

FIG. 1 is a application environment diagram of a log anomaly detection method according to an embodiment of the present disclosure;

FIG. 2 is a schematic flowchart of a log anomaly detection method according to an embodiment of the present disclosure;

FIG. 3 is a schematic flowchart of a pre-processing method before a log anomaly detection according to an embodiment of the present disclosure;

FIG. 4 is a structural block diagram of a log anomaly detection apparatus according to an embodiment of the present disclosure;

FIG. 5 is a diagram of an internal structure of a computer device according to an embodiment of the present disclosure.

### DETAILED DESCRIPTION

In order to provide a clearer understanding of the objectives, technical solutions, and advantages of the present disclosure, the present disclosure is further described in detail in conjunction with accompanying drawings and embodiments below. It is to be understood that the specific embodiments described herein are used to explain the present disclosure rather than limit the present disclosure.

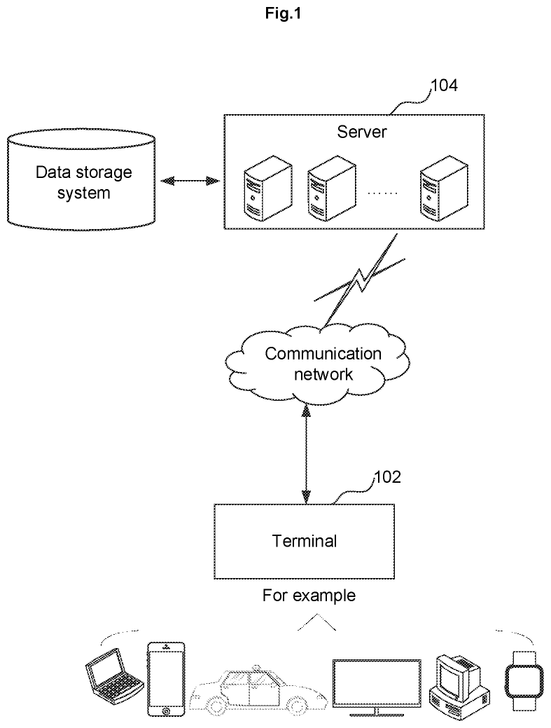

A log anomaly detection method provided by an embodiment of the present disclosure can be applied to an application environment shown in FIG. 1. A terminal 102 communicates with a server 104 through a network. A data storage system may store data required to be processed by the server 104. The data storage system may be integrated on the server 104, and may also be placed on a cloud or other network servers. The terminal 102 may include but not limited to various personal computers, laptops, smart phones, tablets, etc. The server 104 may be implemented by a standalone server, or a server cluster formed by multiple servers.

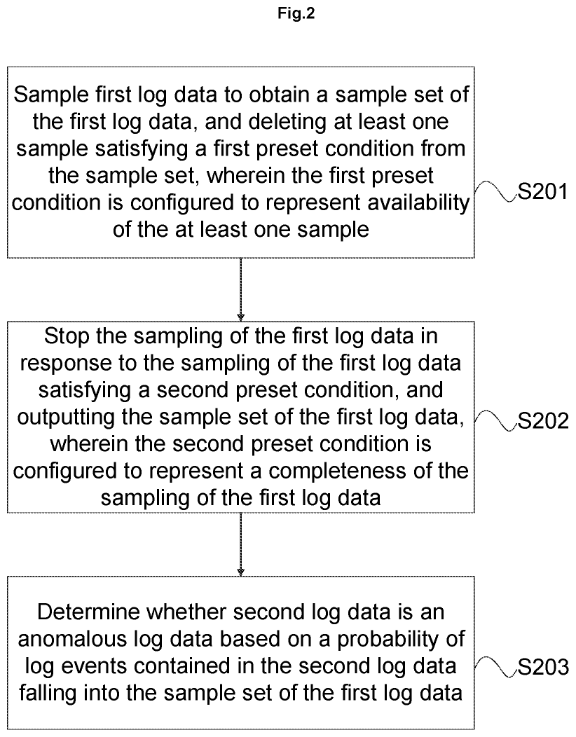

In an embodiment, as shown in FIG. 2, provides a log anomaly detection method. In this embodiment, the method being applied to a terminal is exemplified, which may be understood that the method may also be applied to a server, or a system including a terminal and a server, and is implemented through interaction of the terminal and the server. In this embodiment, the method includes the following steps:
Step 201: first log data to obtain a sample set of the first log data is sampled, and at least one sample satisfying a first preset condition from the sample set is deleted, where the first preset condition is configured to represent availability of the at least one sample.

The availability of the sample includes the time of the sample, the importance of the sample, or other preset indicators. The sample with low availability is selected to be deleted to ensure that a sampled sample is configured with high availability. The availability of the sample is updated in real time for sampling of the first log data to ensure that a sample sampled each time is a sample with higher availability.
Step 202: the sampling of the first log data is stopped in response to where the sampling of the first log data satisfying a second preset condition, and the sample set of the first log data is outputted, wherein the second preset condition is configured to represent a completeness of the sampling of the first log data.

The sampling completeness includes the number of iterations of the sample, whether sample distribution is converged, sample computation time, or other preset indicators. In response to the sampling completeness being high, the sampling of the first log data is stopped to reduce sampling and computational resources. The sample set of the first log data outputted after sampling may be considered as an approximate representation of underlying distribution of the first log data.
Step 203: whether second log data is an anomalous log data is determined based on a probability of log events contained in the second log data falling into the sample set of the first log data.

Because the sample set of the first log data may be considered as the approximate representation of the underlying distribution of the first log data, the sample set is adopted as a basis for log anomaly detection. By calculating the probability of the log events from the second log data falling into the sample set of the first log data, whether the second log data is the anomalous log data is determined.

Based on the log anomaly detection method, by sampling the first log data, the sample with the low availability is deleted in the sampling process; the sampling of the first log data is stopped in response to the sampling completeness being high, and the sample set of the first log data is outputted; and whether the second log data is the anomalous data is determined based on the probability of the log events from the second log data falling into the sample set of the first log data. Due to real-time updating of the sample set based on the sample availability during sampling, dynamic adaption to changes of the log data can be realized; and anomaly detection can be continuously and effectively performed on the dynamic log data, thereby improving the anomaly detection accuracy and detection efficiency of the dynamic log data.

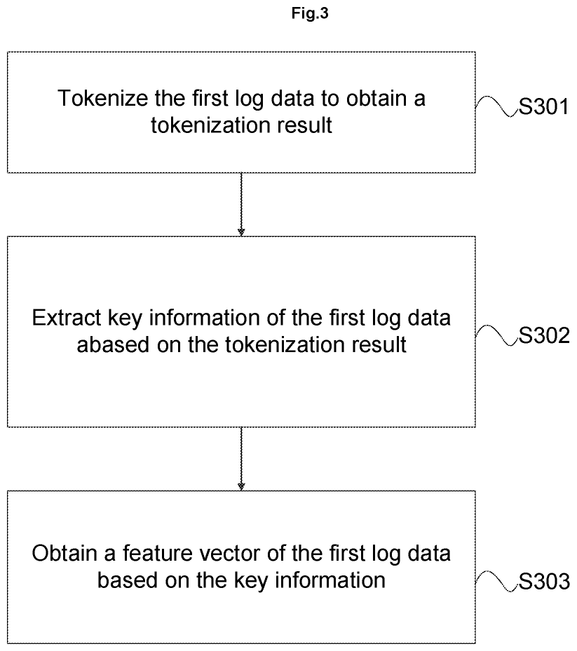

In an embodiment, as shown in FIG. 3, before sampling the first log data, the method further includes:
Step 301: the first log data is tokenized to obtain a tokenization result.
Step 302: key information of the first log data is extracted based on the tokenization result.
Step S303: a feature vector of the first log data is obtained based on the key information.

Since the first log data is sourced from different origins, the first log data needs to be pre-processed before being sampled. The first log data is tokenized to obtain a tokenization result, the key information is extracted, and the unstructured first log data is converted into the structured feature vector. Preprocessing methods may include natural language processing methods such as term frequency-inverse document frequency (TF-IDF) and word embeddings, or other technologies for extracting features specific to the log data, which are not limited by the present disclosure.

In this embodiment, before sampling the first log data, feature extraction is first performed on the first log data, thereby facilitating subsequent selecting of sampled samples of the first log data, and improving the log data processing efficiency.

In an embodiment, the sampling of the first log data includes: a first sample is selected from the first log data; a second sample is generated based on the first sample; and a probability of the first sample in a target distribution, a probability of the second sample in the target distribution, a probability of the first sample in a proposed distribution and a probability of the second sample in the proposed distribution are calculated, and whether the second sample is retained is determined based on the probability of the first sample in the target distribution and the probability of the second sample in the target distribution, the probability of the first sample in the proposed distribution and the probability of the second sample in the proposed distribution, wherein the target distribution is a log data distribution corresponding to the first sample, and the proposed distribution is a log data distribution corresponding to the second sample.

An initial sample point is randomly selected from the preprocessed first log data as the first sample, which serves as a starting point for sampling forget-memory Markov Chain Monte Carlo, alternatively, the first sample is determined based on a preset heuristic strategy, such as a method for selecting a central data point, which is not limited by the present disclosure. The second sample is generated based on the first sample, and serves as a proposed sample point. The probability of the first sample in a target distribution (p(old)), the probability of the second sample in the target distribution (p(new)), the probability of the first sample in a proposed distribution (q(old|new)), and the probability of the second sample in the proposed distribution (q(new|old)) are calculated, and decision making is performed by utilizing the Metropolis-Hastings criterion, wherein Metropolis-Hastings is a sampling method in the Monte Carlo Markov chain, and has a specific formula:

$$α = min ( 1 , \frac{p ( old ) * q ( old \vert new )}{p ( new ) * q ( new \vert old )} )$$

In response to a randomly-generated number from a uniform distribution between 0 and 1 being less than α, the second sample is accepted; or otherwise, the current sample is kept unchanged.

In this embodiment, by sampling and probability computations on the first log data, the log data distribution can obtained even in response to the first log data being complex or has a high dimensionality, thereby improving the accuracy of log data distribution sampling and then improving the accuracy of log data anomaly detection.

In an embodiment, the first preset condition satisfies at least one of the followings: a retention time period of the sample being longer than a first preset value, and a weight of the sample being less than a second preset value.

The first preset condition is configured to represent the availability of the sample. In this embodiment of the present disclosure, the availability of the sample is evaluated based on the sample retention time and sample weight. In response to the retention time period of the sample being longer than the first preset value, it indicates that the sample is too old and has lower availability. In response to the weight of the sample is less than the second preset value, it indicates that the sample has lower importance and availability. Therefore, selective forgetting of samples that satisfy the first preset condition is performed to ensure real-time updating of the samples.

In this embodiment, by selectively forgetting samples that are too old and have low importance, the real-time update of the samples is ensured. In scenarios where log data changes along with time or situations, anomaly detection can be continuously and effectively performed without manual readjustment or training of a model; and the increase in computation quantity of log anomaly detection caused by a large sample size is avoided, and the efficiency and accuracy of log anomaly detection are improved.

In an embodiment, the second preset condition satisfies at least one of the followings: the number of iterations of the sample reaching a third preset value, a distribution of the sample reaching convergence, and a computation time period of the sample reaching a fourth preset value.

The second preset condition is configured to represent the sampling completeness. In this embodiment of the present disclosure, the sampling completeness is evaluated based on the aspects such as the number of iterations of the sample, the sample distribution convergence, and the sample computation time. In response to the number of iterations of the sample reaching the third preset value, it indicates that the sample has undergone sufficient iterations. In response to the sample distribution reaching convergence, it means that the sampled sample set can represent the data distribution of the first log data. In response to the computation time of the sample reaching the fourth preset value, it signifies that the sampling process is sufficiently thorough. Therefore, under the condition of satisfying the above second preset condition, the sampling of the first log data is stopped, and sampling results are outputted as a collection.

In this embodiment, under the condition of satisfying the above second preset condition, the sampling of the sample with high completeness is stopped, thereby avoiding waste of computational resources, increasing a utilization rate of the computational resources, ensuring that sampling points can accurately represent distribution of the first log data, and then improving anomaly detection accuracy of the log data.

In an embodiment, determining whether the second log data is the anomalous log data based on the probability includes: an anomaly score for each log event in the second log data is generated based on the probability of log events from the second log data falling into the sample set of the first log data; in response to the anomaly score exceeding a fifth preset value, an anomaly alert is triggered, and the second log data triggered anomaly is extracted and processed.

By calculating the probability of the second log data within the sample set of the first log data, the anomaly score is generated for each log event in the second log data. In response to the anomaly score of the log event exceeding the fifth preset value, it indicates that the second log data is anomalous. In this case, the anomaly alert is generated, and the anomalous second log data is extracted for further processing of existing anomalies.

In this embodiment, by processing the second log data with a high anomaly score, the adverse impact of anomalous log data on the working state of a system is avoided, thereby improving the working stability of the system.

It is to be understood that although the steps in flowcharts related to the above embodiments are shown sequentially based on the direction of arrows, these steps are not necessarily performed in an order indicated by the arrows. Unless explicitly stated in this specification, there are no strict sequential limitations on the execution of these steps, and these steps may be executed in a different order. Furthermore, at least some of the steps in the flowcharts related to the above embodiments may include multiple steps or multiple stages, which may not be completed at the same time but may be executed at different times. These steps or stages are not necessarily sequentially performed, but may be performed in a rotating or alternating manner with other steps or at least some of the steps or stages in other steps.

Based on the same inventive concept, an embodiment of the present disclosure further provides a log anomaly detection apparatus for implementing the above involved log anomaly detection method. The implementation solution provided by the apparatus for solving the problems is similar to the implementation solution recorded in the above method. Therefore, specific limitations in at least one log anomaly detection apparatus embodiments provided below can be referred to the limitations of the log anomaly detection method described above, and are not repeated herein.

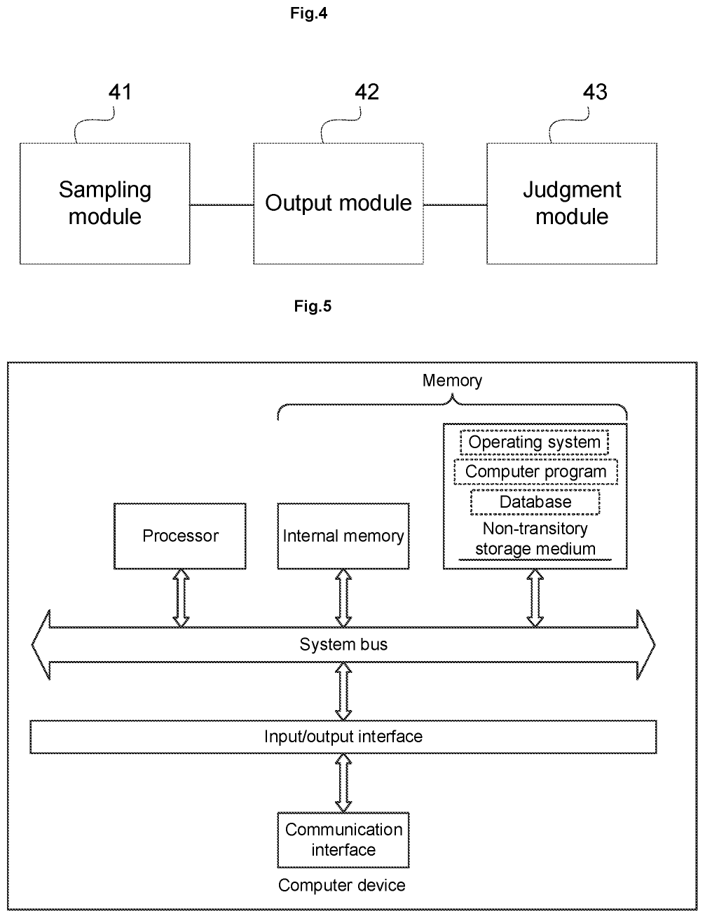

In an embodiment, as shown in FIG. 4, a log anomaly detection apparatus is provided, and includes a sampling module 41, an output module 42, and a judgment module 43.

The sampling module 41 is configured to sample first log data to obtain a sample set of the first log data, and deleting at least one sample satisfying a first preset condition from the sample set, wherein the first preset condition is configured to represent availability of the at least one sample;
the output module 42 is configured to stop the sampling of the first log data in response to the sampling of the first log data satisfying a second preset condition, and outputting the sample set of the first log data, wherein the second preset condition is configured to represent a completeness of the sampling of the first log data;
the judgment module 43 is configured to whether second log data is an anomalous log data based on a probability of log events contained in the second log data falling into the sample set of the first log data.

Various modules in the above log anomaly detection apparatus may be all or partly implemented by software, hardware, and a combination thereof. The above various modules may be embedded in or independent of a processor in a computer device in a hardware form, and may also be stored in a memory of the computer device in a software form, such that the processor can call and execute operations corresponding to the various modules.

In an embodiment, a computer device is provided. The computer device may be a server, with an internal structure diagram shown in FIG. 5. The computer device includes a processor, a memory, an input/output interface (I/O), and a communication interface. The processor, the memory, and the input/output interface are connected through a system bus, and the communication interface is connected to the system bus through the input/output interface. The processor of the computer device is configured to provide computation and control capabilities. The memory of the computer device includes a non-transitory storage medium and an internal memory. The non-transitory storage medium stores an operating system, a computer program, and a database. The internal memory provides an environment for running of the operating system and the computer program in the non-transitory storage medium. The database of the computer device is configured to store log data. The input/output interface of the computer device is configured to exchange information between the processor and a peripheral device. The communication interface of the computer device is configured to communicate with an external terminal through network connection. The computer program, in response to executed by the processor, implements the log anomaly detection method.

Those skilled in the art can understand that the structure shown in FIG. 5 is only a block diagram of a partial structure relevant to the solutions of the present disclosure, and does not constitute a limitation on the computer device to which the solutions of the present disclosure are applied. The specific computer device may include more or fewer components than those shown in the figure, or combine certain components, or have different arrangements of components.

In an embodiment, a computer device is provided, and includes a memory and a processor. The memory stores a computer program, and the processor executes the computer program to achieve the following steps:
first log data to obtain a sample set of the first log data is sampled, and at least one sample satisfying a first preset condition from the sample set is deleted, where the first preset condition is configured to represent availability of the at least one sample; the sampling of the first log data is stopped in response to where the sampling of the first log data satisfying a second preset condition, and the sample set of the first log data is outputted, wherein the second preset condition is configured to represent a completeness of the sampling of the first log data; whether second log data is an anomalous log data is determined based on a probability of log events contained in the second log data falling into the sample set of the first log data.

In an embodiment, the processor executes the computer program to further achieve the following steps:
the first log data is tokenized to obtain a tokenization result; key information of the first log data is extracted based on the tokenization result; and a feature vector of the first log data is obtained based on the key information.

In an embodiment, the processor executes the computer program to further achieve the following steps:
a first sample is selected from the first log data; a second sample is generated based on the first sample; and a probability of the first sample in a target distribution, a probability of the second sample in the target distribution, a probability of the first sample in a proposed distribution and a probability of the second sample in the proposed distribution are calculated, and whether the second sample is retained is determined based on the probability of the first sample in the target distribution and the probability of the second sample in the target distribution, the probability of the first sample in the proposed distribution and the probability of the second sample in the proposed distribution, wherein the target distribution is a log data distribution corresponding to the first sample, and the proposed distribution is a log data distribution corresponding to the second sample.

In an embodiment, the processor executes the computer program to further achieve the following steps:
a Laplace distribution of the first sample is obtained; expected values of various samples relative to the first sample are calculated based on the Laplace distribution of the first sample; and
the second sample is generated based on the expected values.

In an embodiment, the processor executes the computer program to further achieve the following steps:
an anomaly score for each log event in the second log data is generated based on the probability of log events from the second log data falling into the sample set of the first log data; in response to the anomaly score exceeding a fifth preset value, an anomaly alert is triggered, and the second log data triggered anomaly is extracted and processed.

In an embodiment, the processor executes the computer program to further achieve the following steps:
in response to the retention time period of the sample being longer than the first preset value, the at least one sample is determined being old and configured with lower availability; in response to the weight of the sample being less than the second preset value, the at least one sample is determined configured with lower importance and availability.

In an embodiment, a non-transitory storage medium is provided and stores a computer program. The computer program, in response to executing by a processor, implements the following steps:
first log data to obtain a sample set of the first log data is sampled, and at least one sample satisfying a first preset condition from the sample set is deleted, where the first preset condition is configured to represent availability of the at least one sample; the sampling of the first log data is stopped in response to where the sampling of the first log data satisfying a second preset condition, and the sample set of the first log data is outputted, wherein the second preset condition is configured to represent a completeness of the sampling of the first log data; whether second log data is an anomalous log data is determined based on a probability of log events contained in the second log data falling into the sample set of the first log data.

In an embodiment, the computer program, in response to executing by the processor, further implements the following steps:
the first log data is tokenized to obtain a tokenization result; key information of the first log data is extracted based on the tokenization result; and a feature vector of the first log data is obtained based on the key information.

In an embodiment, the computer program, in response to executing by the processor, further implements the following steps:
a first sample is selected from the first log data; a second sample is generated based on the first sample; and a probability of the first sample in a target distribution, a probability of the second sample in the target distribution, a probability of the first sample in a proposed distribution and a probability of the second sample in the proposed distribution are calculated, and whether the second sample is retained is determined based on the probability of the first sample in the target distribution and the probability of the second sample in the target distribution, the probability of the first sample in the proposed distribution and the probability of the second sample in the proposed distribution, wherein the target distribution is a log data distribution corresponding to the first sample, and the proposed distribution is a log data distribution corresponding to the second sample.

In an embodiment, the computer program, in response to executing by the processor, further implements the following steps:
a Laplace distribution of the first sample is obtained; expected values of various samples relative to the first sample are calculated based on the Laplace distribution of the first sample; and
the second sample is generated based on the expected values.

In an embodiment, the computer program, in response to executing by the processor, further implements the following steps:
an anomaly score for each log event in the second log data is generated based on the probability of log events from the second log data falling into the sample set of the first log data; in response to the anomaly score exceeding a fifth preset value, an anomaly alert is triggered, and the second log data triggered anomaly is extracted and processed.

In an embodiment, the computer program, in response to executing by the processor, further implements the following steps:
in response to the retention time period of the sample being longer than the first preset value, the at least one sample is determined being old and configured with lower availability; in response to the weight of the sample being less than the second preset value, the at least one sample is determined configured with lower importance and availability.

It is to be noted that user information (including but not limited to user device information, user personal information, etc.) and data (including but not limited to data for analysis, stored data, displayed data, etc.) involved in the present disclosure are all information and data authorized by the user or sufficiently authorized by each side, and related data collection, use and processing need to comply with relevant laws, regulations, and standards of related countries and regions.

Those of ordinary skill in the art can understand that all or part of the processes in the above embodiment methods may be implemented by instructing relevant hardware through the computer program. The computer program may be stored in the non-volatile non-transitory storage medium. The computer program, in response to executing, may include the processes of the above method embodiments. Any reference to the memory, the database, or other media used in the various embodiments provided in the present disclosure can include at least one of a non-volatile memory and a volatile memory. The non-volatile memory may include a read-only memory (ROM), magnetic tape, a floppy disk, a flash memory, an optical memory, a high-density embedded non-volatile memory, a resistive random access memory (ReRAM), a magnetoresistive random access memory (MRAM), a ferroelectric random access memory (FRAM), a phase change memory (PCM), graphene memory, and etc. The volatile memory may include a random access memory (RAM), or an external high-speed cache memory, etc. As an explanation but not as a limitation, the RAM may be in various forms, such as a static random access memory (SRAM), or a dynamic random access memory (DRAM), etc. The databases involved in the various embodiments provided in the present disclosure may include at least one of a relational database and a non-relational database. The non-relational database may include a blockchain-based distributed database, etc., which is not limited to these databases. The processor involved in the various embodiments provided in the present disclosure may be a general-purpose processor, a central processor, a graphics processor, a digital signal processor, a programmable logic device, a data processing logic device based on quantum computing, etc., which is not limited to these examples.

Various technical features of the foregoing embodiments may be combined at will. For brevity of the description, it is unnecessary to describe all possible combinations of the various technical features of the above-mentioned embodiments, however, the combinations of these technical features should fall within the scope recorded by this specification as long as there is no contradiction.

The above-mentioned embodiments show only several implementations of the present disclosure, which are described in a specific and detailed manner, but are not to be construed as a limitation to the patent scope of the present disclosure. It is to be noted that those of ordinary skill in the art may also make several modifications and improvements without departing from the concept of the present disclosure, and these modifications and improvements fall within the scope of protection of the present disclosure. Therefore, the scope of protection of the present disclosure shall be subject to the appended claims.

What is claimed is:

1. A log anomaly detection method, comprising:
sampling first log data to obtain a sample set of the first log data, and deleting at least one sample satisfying a first preset condition from the sample set, wherein the first preset condition is configured to represent availability of the at least one sample;
stopping the sampling of the first log data in response to the sampling of the first log data satisfying a second preset condition, and outputting the sample set of the first log data, wherein the second preset condition is configured to represent a completeness of the sampling of the first log data;
determining whether second log data is an anomalous log data based on a probability of log events contained in the second log data falling into the sample set of the first log data.

2. The log anomaly detection method as claimed in claim 1, wherein before sampling the first log data, the method further comprises:
tokenizing the first log data to obtain a tokenization result;
extracting key information of the first log data based on the tokenization result;
obtaining a feature vector of the first log data based on the key information.

3. The log anomaly detection method as claimed in claim 1, wherein sampling the first log data comprises:
selecting a first sample from the first log data;
generating a second sample based on the first sample;
calculating a probability of the first sample in a target distribution, a probability of the second sample in the target distribution, a probability of the first sample in a proposed distribution and a probability of the second sample in the proposed distribution, and determining whether the second sample is retained based on the probability of the first sample in the target distribution, the probability of the second sample in the target distribution, the probability of the first sample in the proposed distribution and the probability of the second sample in the proposed distribution, wherein the target distribution is a log data distribution corresponding to the first sample, and the proposed distribution is a log data distribution corresponding to the second sample.

4. The log anomaly detection method as claimed in claim 3, wherein generating the second sample based on the first sample comprises:
obtaining a Laplace distribution of the first sample;
calculating expected values of various samples relative to the first sample based on the Laplace distribution of the first sample;
generating the second sample based on the expected values.

5. The log anomaly detection method as claimed in claim 1, wherein the first preset condition satisfies at least one of the followings: a retention time period of the sample being longer than a first preset value, and a weight of the sample being less than a second preset value.

6. The log anomaly detection method as claimed in claim 1, wherein the second preset condition satisfies at least one of the followings: the number of iterations of the sample reaching a third preset value, a distribution of the sample reaching convergence, and a computation time period of the sample reaching a fourth preset value.

7. The log anomaly detection method as claimed in claim 1, wherein determining whether the second log data is the anomalous log data based on the probability of log events from the second log data falling into the sample set of the first log data comprises:
generating an anomaly score for each log event in the second log data based on the probability of log events from the second log data falling into the sample set of the first log data;
in response to the anomaly score exceeding a fifth preset value, triggering an anomaly alert, and extracting and processing the second log data triggered anomaly.

8. The log anomaly detection method as claimed in claim 5, wherein the method further comprises:
in response to the retention time period of the sample being longer than the first preset value, determining the at least one sample being old and configured with lower availability;
in response to the weight of the sample being less than the second preset value, determining the at least one sample configured with lower importance and availability.

9. A computer device, comprising a memory, a processor, and a computer program stored in the memory and run on the processor, in response to executing the computer program, wherein the processor implements the log anomaly detection method, wherein the log anomaly detection method comprising the following steps:
sampling first log data to obtain a sample set of the first log data, and deleting at least one sample satisfying a first preset condition from the sample set, wherein the first preset condition is configured to represent availability of the at least one sample;
stopping the sampling of the first log data in response to the sampling of the first log data satisfying a second preset condition, and outputting the sample set of the first log data, wherein the second preset condition is configured to represent a completeness of the sampling of the first log data;
determining whether second log data is an anomalous log data based on a probability of log events contained in the second log data falling into the sample set of the first log data.

10. A non-transitory storage medium, wherein the non-transitory storage medium is configured to store a computer program, and in response to executed by a processor, the computer program implements the log anomaly detection method, wherein the log anomaly detection method comprising the following steps:
sampling first log data to obtain a sample set of the first log data, and deleting at least one sample satisfying a first preset condition from the sample set, wherein the first preset condition is configured to represent availability of the at least one sample;
stopping the sampling of the first log data in response to the sampling of the first log data satisfying a second preset condition, and outputting the sample set of the first log data, wherein the second preset condition is configured to represent a completeness of the sampling of the first log data;
determining whether second log data is an anomalous log data based on a probability of log events contained in the second log data falling into the sample set of the first log data.
